(19) United States
(12) Patent Application Publication
(10) Pub. No.: US 2016/0216446 A1
(43) Pub. Date: Jul. 28, 2016

(54) APPARATUS FOR MONITORING OPTICAL SIGNAL

(71) Applicant: ELECTRONICS AND TELECOMMUNICATIONS RESEARCH INSTITUTE, Daejeon-si (KR)

(72) Inventors: Sae Kyoung KANG, Daejeon-si (KR); Heuk PARK, Daejeon-si (KR); Sang Soo LEE, Daejeon-si (KR)

(21) Appl. No.: 15/005,159

(22) Filed: Jan. 25, 2016

(30) Foreign Application Priority Data
Jan. 28, 2015 (KR) 10-2015-0013768

(51) Int. Cl. G02B 6/12; G02B 6/134

(52) U.S. Cl. CPC G02B 6/12004; G02B 6/12002; G02B 6/134; G02B 2006/12123; G02B 2006/12126; G02B 2006/12138; G02B 2006/12107

(57) ABSTRACT

An apparatus for monitoring an optical signal includes a light absorbing layer formed on an optical waveguide consisting of a core layer and upper and lower cladding layers; and a photodiode comprising electrodes arranged on both the optical waveguide and the light absorbing layer.

### CROSS-REFERENCE TO RELATED APPLICATION(S)

This application claims priority from Korean Patent Application No. 10-2015-0013768, filed on Jan. 28, 2015, in the Korean Intellectual Property Office, the disclosure of which is incorporated herein by reference in its entirety.

### BACKGROUND

1. Field

The following description relates to an optical communication, and more particularly, to an apparatus for monitoring an optical signal in an optical waveguide-based optical device.

2. Description of the Related Art

In an optical communication system, an optical transceiver module that plays a key role in opto-electrical and electro-optical conversion is expected to be compact, low-cost, and low power consumption by monolithic integration in which active and passive optical devices are fabricated on the same process platform. For the monolithic integration, an optical waveguide-based structure for monitoring an optical signal is required.

U.S. Pat. No. 7,305,185, assigned to Enablence, which is a vendor for optical devices and modules, discloses a configuration for optical channel monitoring. In this document, in order to monitor channel wavelength of an optical signal, an optical tap is added to an optical waveguide, which splits the optical signal into a desired portion of light that goes to a demultiplexer providing optical outputs. The split optical signals are converted into electric signals by an external multi-channel photodiode, which causes an increase in the overall size of the module.

U.S. Pat. No. 7,957,438, assigned to JDS Uniphase, discloses a configuration for monitoring light. An optical signal launched from a light source to a fiber is mostly transmitted through a core of the fiber, and the remaining portion is transmitted through the cladding of the fiber. In this configuration, a photodiode is placed on the top of the cladding of the fiber and monitors the optical signal. Such a configuration increases the structural complexity in the packaging of the photodiode and the overall size of the package.

### SUMMARY

The following description relates to an apparatus for monitoring an optical signal based on an optical waveguide, which is advantageous for monolithic integration.

In one general aspect, there is provided An apparatus for monitoring an optical signal, including: a light absorbing layer formed on an optical waveguide consisting of a core layer and upper and lower cladding layers; and a photodiode including electrodes arranged on both the optical waveguide and the light absorbing layer.

In another general aspect, there is provided an apparatus for monitoring an optical signal, including: a light absorbing layer formed on an optical waveguide consisting of a core layer and upper and lower cladding layers; and a photodiode including electrodes arranged on the light absorbing layer.

Other features and aspects will be apparent from the following detailed description, the drawings, and the claims.

### BRIEF DESCRIPTION OF THE DRAWINGS

FIG. 1 is a plan view of an apparatus for monitoring an optical signal which is integrated onto an optical waveguide according to the first exemplary embodiment of the present invention.

FIGS. 2A and 2B are diagram illustrating examples of shapes of electrodes of a photodiode according to the present invention.

FIG. 3 is a plan view of another example of an apparatus for monitoring an optical signal, which is integrated onto an optical waveguide according to the first exemplary embodiment.

FIGS. 4A and 4B are diagrams illustrating examples of shapes of electrodes of a photodiode according to the exemplary embodiment.

FIGS. 5A and 5B are cross-sectional views of the apparatus for monitoring an optical signal, which is integrated onto an optical waveguide, according to the exemplary embodiment of FIG. 1.

FIGS. 6A and 6B are cross-sectional views of an apparatus for monitoring an optical signal which is integrated onto an optical waveguide according to another exemplary embodiment of the present invention.

Fig FIGS. 7 and 8 are plan view of an apparatus for monitoring an optical signal which is integrated onto an optical waveguide according to a second exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The present invention relates to an apparatus for monitoring an optical signal, which is integrated onto an optical waveguide, and provides mainly two exemplary embodiments thereof according to the positions at which electrodes of a photodiode of the apparatus for detecting optical signals are formed.

According to a first exemplary embodiment, an apparatus for monitoring an optical signal has electrodes of a photodiode formed on both an optical waveguide and a light absorbing layer.

According to a second exemplary embodiment, an apparatus for monitoring an optical signal has all electrodes of a photodiode formed only on a light absorbing layer.

The photodiode of the apparatus converts an optical signal detected from the optical waveguide into an electrical signal.

Each exemplary embodiment will be described in detail with reference to the accompanying drawings below.

### FIRST EXEMPLARY EMBODIMENT

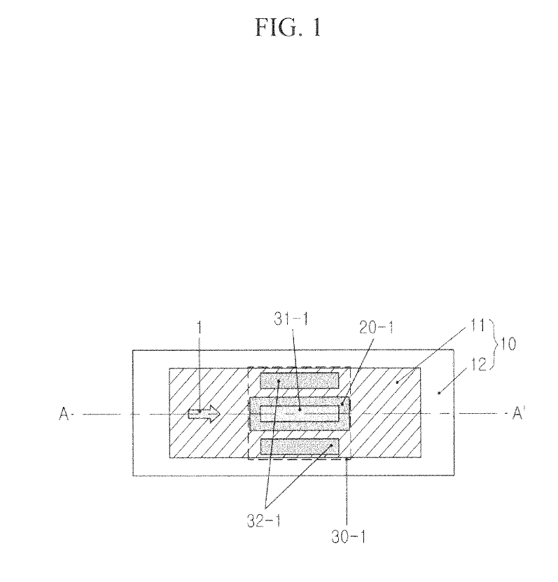

FIG. 1 is a plan view of an apparatus for monitoring an optical signal which is integrated onto an optical waveguide according to the first exemplary embodiment of the present invention.

Referring to FIG. 1, the apparatus includes a light absorbing layer 20-1 and a photodiode 30, wherein the light absorbing layer 20-1 is formed on a top of the optical waveguide 10 that is a monitoring target and the photodiode 30 is formed on the top of the optical waveguide 10 and the light absorbing layer 20-1.

The optical waveguide 10 is a target for monitoring an optical signal and consists of a core layer 11, an upper and lower cladding layers 12.

The light absorbing layer 20-1 is formed on the core layer 11 of the optical waveguide 10 and absorbs an optical signal propagating through the core layer 11.

The photodiode 30-1 includes an electrode 31-1 formed on the light absorbing layer 20-1 and electrodes 32-1 formed on the core layer 11 of the optical waveguide. Each electrode 31-1 and 32-1 may be formed by the ion doping technique (n-type doping and p-type doping). Although the positive and negative electrodes 31-1 and 32-1 of the photodiode 30-1 are shown as a rectangle in the drawings, aspects of the present disclosure are not limited thereto, such that the electrodes of the photodiode 30-1 may be formed in various shapes, such as a circle, as well as a rectangle. In addition, various embodiments may be available for the shape of electrodes of the photodiode 30-1 relative to a direction along which light travels.

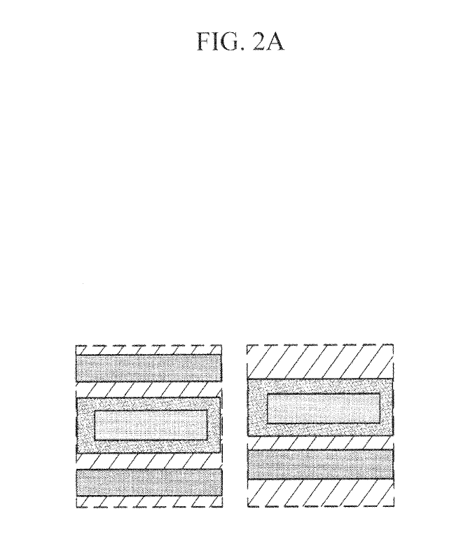

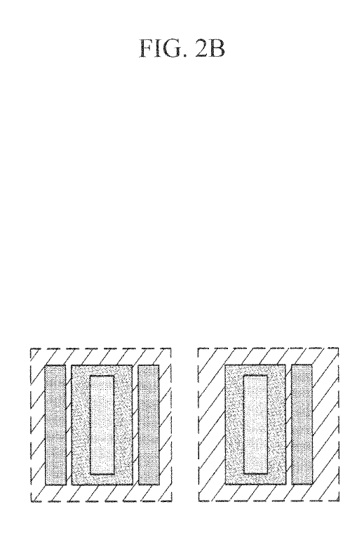

FIGS. 2A and 2B are diagram illustrating examples of shapes of electrodes of a photodiode according to the present invention.

Referring to FIG. 2A, positive and negative electrodes of the photodiode are arranged parallel to a direction along which an optical signal travels. Referring to FIG. 2B, the positive and negative electrodes of the photodiode are arranged perpendicular to a direction along which the optical signal travels. The diagrams on the left in each of FIGS. 2A and 2B illustrate two electrodes being formed on a core layer of the optical waveguide, and the diagrams on the right illustrate a single electrode being formed on the core layer.

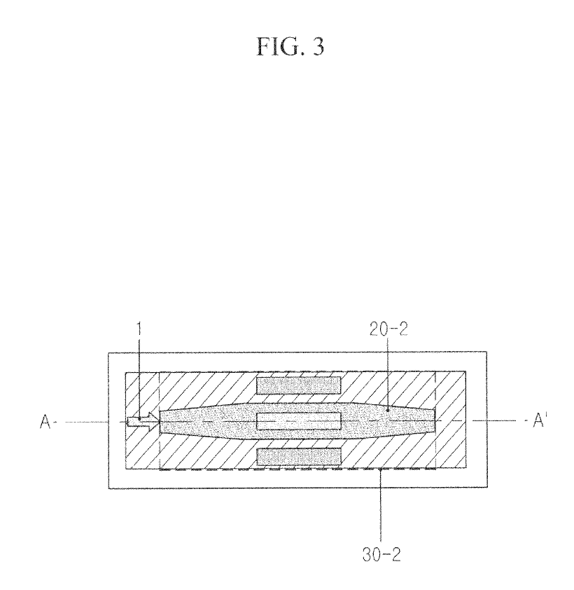

FIG. 3 is a plan view of another example of an apparatus for monitoring an optical signal, which is integrated onto an optical waveguide according to the first exemplary embodiment.

Referring to FIG. 3, in order to reduce the reflection of light signal near a light observing layer 20-2, both ends of a light absorbing layer 20-2 are tapered such that the refractive index thereof is gradually changed. Other components of the apparatus are the same as those of the apparatus illustrated in FIG. 1, and the detailed description thereof will be omitted.

In addition, various embodiments may be available for the shape of electrodes of the photodiode 30-2 of FIG. 3 relative to a direction along which light travels.

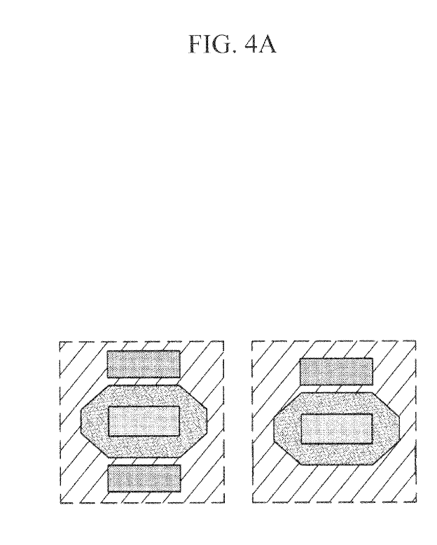

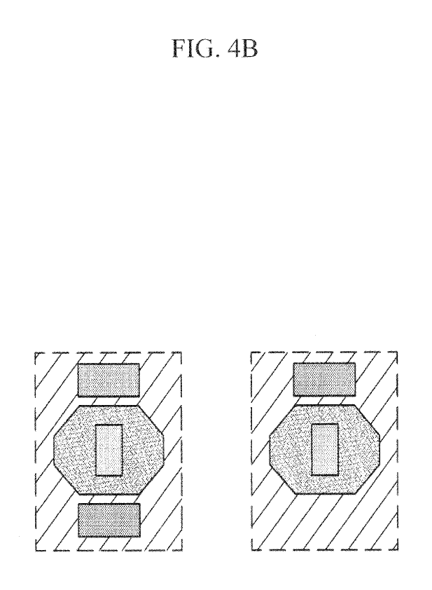

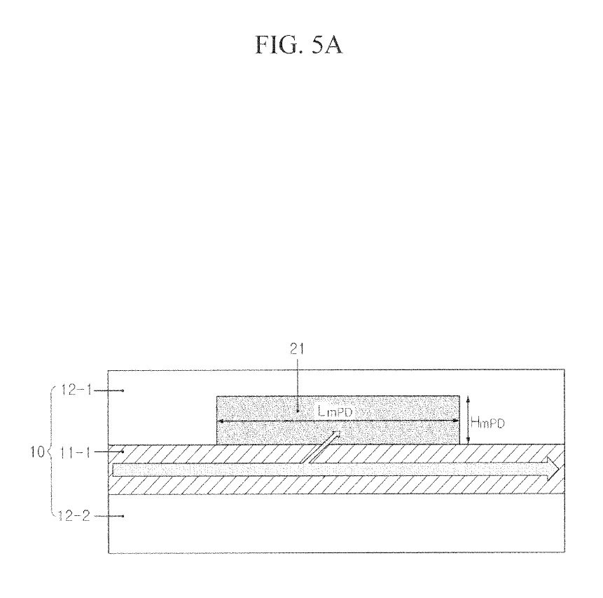

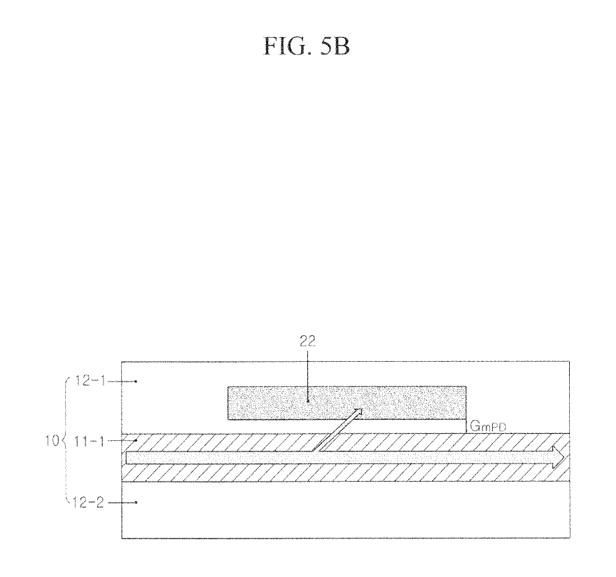

FIGS. 4A and 4B are diagrams illustrating examples of shapes of electrodes of a photodiode according to the exemplary embodiment.

Referring to FIG. 4A, positive and negative electrodes of the photodiode are arranged parallel to the direction along which an optical signal travels. Referring to FIG. 4B, the positive and negative electrodes of the photodiodes are arranged perpendicular to the direction along which an optical signal travels. The diagrams on the left in each of FIGS. 4A and 4B illustrate two electrodes being formed on a core layer of the optical waveguide, and the diagrams on the right illustrate a single electrode being formed on the core layer.

Cross-sectional views of the apparatus taken long line A-A′ of FIG. 1 and FIG. 3 will be described.

FIGS. 5A and 5B are cross-sectional views of the apparatus for monitoring an optical signal, which is integrated onto an optical waveguide, according to the exemplary embodiment of FIG. 1.

FIG. 5A shows how the apparatus monitors the optical signal using a photodiode formed on the optical waveguide 10. An applied optical signal is transmitted via an optical waveguide consisting of a core layer 11-1 (refractive index thereof is n2) and cladding layers 12-1 and 12-2 (refractive index thereof is n3) with different refractive indices. The relationship of the refractive indices of the core layer 11-1 (n2), which is a medium, and the cladding layers 12-1 and 12-2 (n3) is expressed mathematically as: “n2>n3.”

The optical signal traveling in the optical waveguide is evanescent wave-coupled to the light absorbing layers (refractive index=n1) 21 with a higher refractive index than that of the core layer (refractive index=n2) 11-1. The relationship of the refractive indices of the core layer 11-1 (n2), which is a medium, and the light absorbing layer 21 (n1) is expressed mathematically as: “n1>n2”.

The amount of optical signal coupled to the light absorbing layer (refractive index=n1) 21 may vary according to the length of the photodiode (length of evanescent-wave coupling, LmPD) of the optical waveguide with a fixed width, a ratio between the thickness (HWG) of the core layer 11-1 of the optical waveguide and the thickness HmPD of the light absorbing layer 21, and quantum efficiency of a working wavelength of the light absorbing layer 21. Specifically, as the length (LmPD) of the photodiode increases, as the light absorbing layer 21 is thicker than the core layer 11-1, or as the quantum efficiency of the light absorbing layer 21 increases, the amount of optical signal launched into the photodiode increases.

As an example of a photodiode for general communications, a silicon photonics-based photodiode is provided, which consists of germanium layer (refractive index: n1−4.3), as a light absorbing layer, being formed on an optical waveguide (core layer: silicon (Si, refractive index: n2−3.5: cladding layer: SiO1, refractive index: n3−4.3). Here, the refractive index represents a value at a wavelength of 1.5 μm.

Although the apparatus shown in FIG. 5B has the same plan view as the apparatus of FIG. 5A, a light absorbing layer 22 of the apparatus in FIG. 5B is not directly attached onto the core layer 11-1 of the optical waveguide, but is formed on the cladding layer 12-1 and placed above the core layer 11-1. The apparatus with the structure according to FIG. 5B is able to detect and monitor the optical signal that travels through the cladding layer 12-1, as well as the optical signal that travels through the core layer 11-1 of the optical waveguide. To implement this structure, integration of the light absorbing layer 22 into the cladding layer 12-1 of the optical waveguide should be possible in the manufacturing process. The amount of evanescent-wave coupling to the light absorbing layer 22 may vary depending on a gap (GmPD) between the core layer 11-1 and the light absorbing layer 22 as well as the parameters mentioned in FIG. 5A.

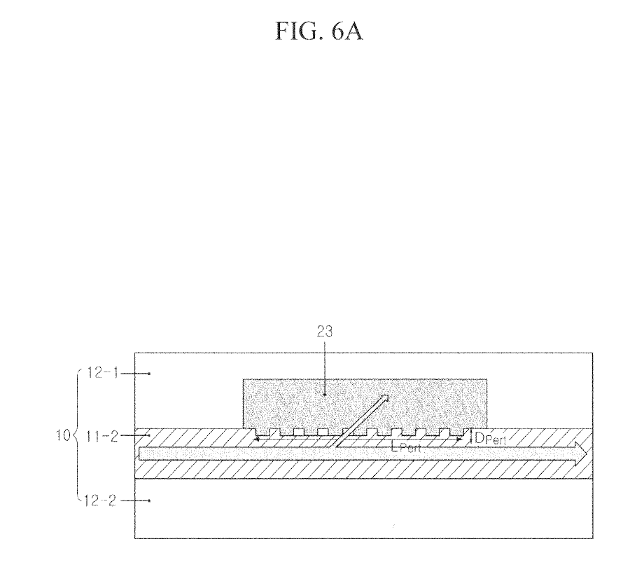

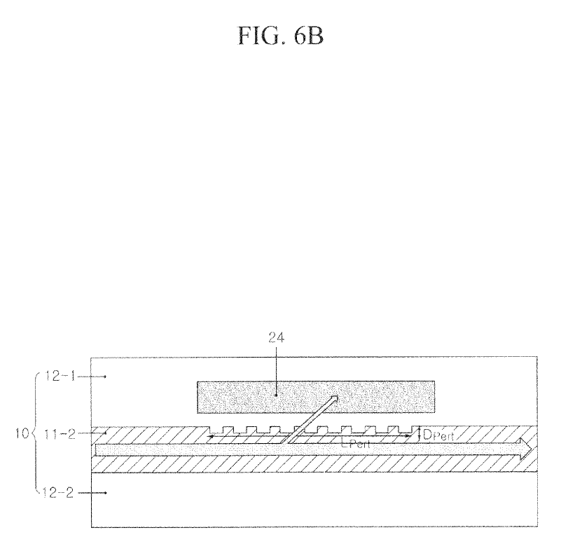

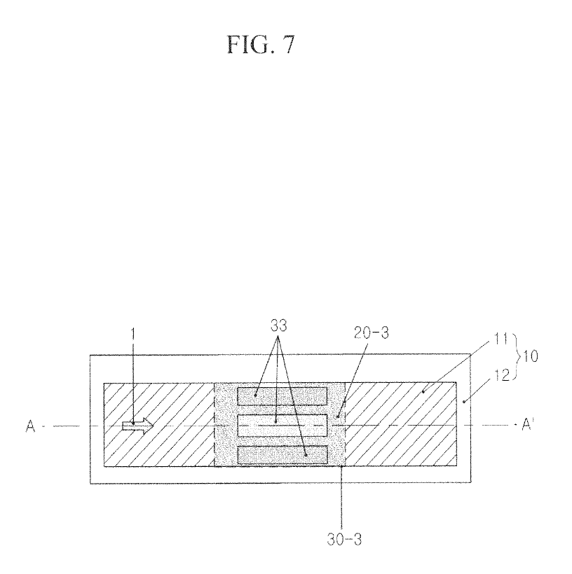

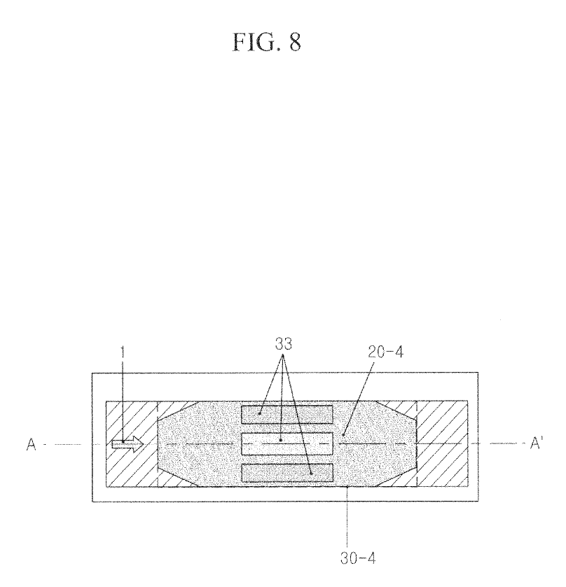

FIGS. 6A and 6B are cross-sectional views of an apparatus for monitoring an optical signal which is integrated onto an optical waveguide according to another exemplary embodiment of the present invention.

Referring to FIGS. 6A and 6B, a perturbation, such as, grating is added onto the core layer 11-2 of an optical waveguide, thereby allowing branching of a part of optical signal traveling in the optical waveguide in a desired direction.

FIG. 6A is a diagram illustrating a light absorbing layer 23 being formed on the perturbation of the core layer 11-2 of the optical waveguide, and FIG. 6B is a diagram illustrating a light absorbing layer 24 being formed on a cladding layer 12-1 on the perturbation of the core layer 11-2 of the optical waveguide. The use of such structures has advantages in that it is possible to selectively monitor a particular wavelength channel of an optical signal traveling in the optical waveguide. The amount of evanescent-wave coupling to the light absorbing layer 23 and 24 may vary depending on the length (LPert) and depth (DPert) of perturbation on the core layer of the optical waveguide of a fixed width.

### SECOND EXEMPLARY EMBODIMENT

FIGS. 7 and 8 are plan view of an apparatus for monitoring an optical signal which is integrated onto an optical waveguide according to a second exemplary embodiment of the present invention.

Referring to FIGS. 7 and 8, the apparatus has the same structure as that of the apparatus shown in FIGS. 1 to 3, other than positive and negative electrodes 33 of a photodiode 30-3 and 30-4 being all formed on a light absorbing layer 20-3 and 20-4. Such structures advantageously enable smaller size of a monitoring photodiode than the photodiode with the electrodes arranged as shown in FIGS. 1 and 3.

In addition, although not illustrated in drawings, the positive and negative electrodes of the photodiode 30-3 and 30-4 may be arranged parallel or perpendicular to a direction 1 in which light travels.

Furthermore, the cross-sectional structures of the apparatus taken along line A-A′ may be the same as those shown in FIGS. 5A to 6B. In comparison to the apparatus of FIGS. 1 and 3, the apparatus shown in FIGS. 7 and 8 is only different in the locations at which the electrodes are formed, and the basic operational principles are the same, a detailed description of which will be thus omitted.

According to the exemplary embodiments, the photodiode that is a photodetector is arranged on the optical waveguide and monitors an optical signal, so that the size of an optical integrated circuit capable of monitoring an optical signal can be remarkably reduced.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for monitoring an optical signal, comprising:
a light absorbing layer formed on an optical waveguide consisting of a core layer and upper and lower cladding layers; and
a photodiode comprising electrodes arranged on both the optical waveguide and the light absorbing layer.

2. The apparatus of claim 1, wherein the electrodes of photodiode are arranged on the light absorbing layer and the core layer of the optical waveguide and formed by an ion doping technique.

3. The apparatus of claim 1, wherein the electrodes of the photodiode are formed perpendicular to a direction along which an optical signal travels.

4. The apparatus of claim 1, wherein the electrodes of the photodiode are formed parallel to a direction along which an optical signal travels.

5. The apparatus of claim 1, wherein both ends of the light absorbing layer are tapered.

6. The apparatus of claim 1, wherein the light absorbing layer is formed on the core layer of the optical waveguide.

7. The apparatus of claim 1, wherein the light absorbing layer is formed on the cladding layer of the optical waveguide and spaced apart from the core layer of the optical waveguide by a predetermined gap (GmPD).

8. The apparatus of claim 1, wherein the core layer of the optical waveguide has grating added thereon.

9. A apparatus for monitoring an optical signal, comprising:
a light absorbing layer formed on an optical waveguide consisting of a core layer and upper and lower cladding layers; and
a photodiode comprising electrodes arranged on the light absorbing layer.

10. The apparatus of claim 9, wherein the electrodes of photodiode are formed by an ion doping technique.

11. The apparatus of claim 9, wherein the photodiode are formed perpendicular to a direction along which an optical signal travels.

12. The apparatus of claim 9, wherein the electrodes of the photodiode are formed parallel to a direction along which an optical signal travels.

13. The apparatus of claim 9, wherein both ends of the light absorbing layer are tapered.

14. The apparatus of claim 9, wherein the light absorbing layer is formed on the core layer of the optical waveguide.

15. The apparatus of claim 9, wherein the light absorbing layer is formed on the cladding layer of the optical waveguide and spaced apart from the core layer of the optical waveguide by a predetermined gap (GmPD).

16. The apparatus of claim 9, wherein the core layer of the optical waveguide has grating added thereon.
